(19) United States
(12) Patent Application Publication
(10) Pub. No.: US 2024/0076011 A1
(43) Pub. Date: Mar. 7, 2024

(54) SNOW VEHICLE

(71) Applicant: Allen Mangum, Idaho Falls, ID (US)

(72) Inventor: Allen Mangum, Idaho Falls, ID (US)

(21) Appl. No.: 18/461,445

(22) Filed: Sep. 5, 2023

Related U.S. Application Data
(60) Provisional application No. 63/403,818, filed on Sep. 5, 2022.
(60) Provisional application No. 63/403,819, filed on Sep. 5, 2022.
(60) Provisional application No. 63/403,820, filed on Sep. 5, 2022.

(51) Int. Cl. B62M 27/02

(52) U.S. Cl. CPC B62M 27/02; B62M 2027/021; B62M 2027/026

(57) ABSTRACT

An apparatus to convert a motorcycle into a snow bike is disclosed. In one or more examples, the apparatus includes a tunnel and a mount plate coupled to the tunnel. In certain examples, the apparatus also includes a pair of mount legs, where each of the pair of mount legs is positionably coupled to the mount plate at a first end and rotationally coupled at a second end to a frame of the motorcycle, and where each of the pair of mount legs is positionable independent of the other mount leg.

### CROSS-REFERENCE TO RELATED APPLICATION

This application claims the benefit of U.S. Provisional Patent Application No. 63/403,818 entitled SNOW VEHICLE and filed on Sep. 5, 2022 for Allen Mangum which is incorporated herein by reference, U.S. Provisional Patent Application No. 63/403,819 entitled SNOW VEHICLE and filed on Sep. 5, 2022 for Allen Mangum which is incorporated herein by reference, and U.S. Provisional Patent Application No. 63/403,820 entitled SNOW VEHICLE and filed on Sep. 5, 2022 for Allen Mangum which is incorporated herein by reference.

### FIELD

This disclosure relates to snow vehicles and more particularly relates to a kit to convert a motorcycle into a snow vehicle.

### BACKGROUND

Motorcycles and motorized snow vehicles such as snowmobiles typically include basic components such a body with seat to accommodate a rider, an engine for propelling the vehicle, handlebars that connect to a front portion of for the vehicle for steering the snow vehicle. However, motorized snow vehicles are typically operated in different conditions than those in which motorcycles are operated. The way an operator rides a motorized snow vehicle with two skis may be different from how an operator rides a motorcycle or from how an operator rides a motorized snow vehicle with one ski. Sometime motorized snow vehicles with one ski are referred to as snow bikes.

### SUMMARY

An apparatus to convert a motorcycle into a snow bike is disclosed. In one or more examples, the apparatus includes a tunnel and a mount plate coupled to the tunnel. In certain examples, the apparatus also includes a pair of mount legs, where each of the pair of mount legs is positionably coupled to the mount plate at a first end and rotationally coupled at a second end to a frame of the motorcycle, and where each of the pair of mount legs is positionable independent of the other mount leg.

In certain examples, the mount plate includes an elongated slot for each of the pair of mount legs. The elongated slots are adapted for the lateral positioning of the pair of mount legs with respect to a centerline. A fastener is provided for each of the pair of mount legs, where the fastener is configured to pass through the slot and secure its respective mount leg to the mount plate. In certain examples, a lateral distance from the centerline of a first one of the pair of mount legs is substantially equivalent to a lateral distance from the centerline of a second one of the pair of mount legs. Alternatively, the lateral distance from the centerline of a first one of the pair of mount legs is greater than a lateral distance from the centerline of a second one of the pair of mount legs.

In certain examples, the apparatus includes a linkage bracket having a first mount point pivotally coupled with a first end of a strut, a second mount point pivotally coupled with a first end of a shock absorber, and a third mount point pivotally coupled with the tunnel. The second end of the strut is pivotally coupled with an upper shock mount of the frame of the motorcycle. In certain examples, a second end of the shock absorber is pivotally coupled with the tunnel. An angle of separation between the strut and the shock absorber may be in a range of between about 70 and about 110 degrees.

In certain examples, another apparatus to convert a motorcycle into a snow bike is disclosed. In other examples, the apparatus includes a rear suspension assembly for converting a rear portion of a motorcycle for use as a snow vehicle. The rear suspension assembly includes a tunnel, a linkage bracket having a first mount point pivotally coupled with a first end of a strut, a second mount point pivotally coupled with a first end of a shock absorber, and a third mount point pivotally coupled with the tunnel.

In certain examples, the apparatus includes a second end of the strut that is pivotally coupled with an upper shock mount of the frame of the motorcycle. The second end of the shock absorber is pivotally coupled with the tunnel. An angle of separation between the strut and the shock absorber in a range of between about 70 and about 110 degrees. In certain examples, the rear suspension assembly also includes a mount plate coupled to the tunnel. A pair of mount legs may be provided, where each of the pair of mount legs is positionably coupled to the mount plate at a first end and rotationally coupled at a second end to a frame of the motorcycle, and where each of the pair of mount legs is positionable independent of the other mount leg. The mount plate, in certain examples, includes an elongated slot for each of the pair of mount legs.

In certain examples, each of the elongated slots is adapted for the lateral positioning of the pair of mount legs with respect to a centerline. A fastener for each of the pair of mount legs, where the fastener is configured to pass through the slot and secure its respective mount leg to the mount plate.

Also disclosed is a snow bike. In certain examples, the snow bike includes a motorcycle frame, and a front suspension assembly coupled at a front of the motorcycle frame, the front suspension assembly having a ski. The snow bike, in certain examples, includes a rear suspension assembly coupled at a rear of the motorcycle frame, where the rear suspension assembly includes a tunnel, and a mount plate coupled to the tunnel, and a pair of mount legs, where each of the pair of mount legs is positionably coupled to the mount plate at a first end and rotationally coupled at a second end to a frame of the motorcycle, and where each of the pair of mount legs is positionable independent of the other mount leg.

### BRIEF DESCRIPTION OF THE DRAWINGS

In order that the advantages of the disclosure will be readily understood, a more particular description of the disclosure briefly described above will be rendered by reference to specific examples that are illustrated in the appended drawings. Understanding that these drawings depict only typical examples of the disclosure and are not therefore to be considered to be limiting of its scope, the disclosure will be described and explained with additional specificity and detail through the use of the accompanying drawings, in which:

FIG. 1 is a perspective view diagram of a snow bike, in accordance with one or more examples of the present disclosure;

FIG. 2 is a side view diagram illustrating a partial view of the snow bike, in accordance with examples of the present disclosure;

FIG. 3a is a perspective view diagram illustrating an example of the rear suspension assembly with the motorcycle portion, in accordance with examples of the present disclosure;

FIG. 3b is a perspective view diagram illustrating an example of the rear suspension assembly without the motorcycle portion, in accordance with examples of the present disclosure;

FIG. 4 is a perspective view diagram illustrating a partial view of the rear suspension assembly, in accordance with examples of the present disclosure;

FIG. 5a is a perspective view diagram illustrating a view of the mounting plate, in accordance with examples of the subject disclosure;

FIG. 5b is a top view diagram illustrating another example of the mounting plate, in accordance with examples of the subject disclosure;

FIG. 6a is a perspective view diagrams illustrating a left side of the mount legs, in accordance with examples of the subject disclosure;

FIG. 6b is a perspective view diagrams illustrating a right side of the mount legs, in accordance with examples of the subject disclosure;

FIG. 7 is a side view diagram illustrating a partial view of the snow bike, in accordance with examples of the subject disclosure;

FIG. 8a is a perspective view diagrams illustrating an example of the jack shaft, in accordance with examples of the present disclosure;

FIG. 8b is a perspective view diagrams illustrating another example of the jack shaft, in accordance with examples of the present disclosure;

FIG. 9 is a perspective view diagram illustrating a partial view of the jack shaft and the sprocket hub, in accordance with examples of the subject disclosure;

FIG. 10a is a perspective view diagram illustrating one example of the drive shaft, in accordance with examples of the subject disclosure;

FIG. 10b is a perspective view diagram illustrating another example of the drive shaft, in accordance with examples of the subject disclosure;

FIG. 11 is a side view diagram illustrating another example of the rear suspension assembly, in accordance with examples of the subject disclosure;

FIG. 12 is a perspective view diagram illustrating one example of the live strut, in accordance with examples of the subject disclosure;

FIG. 13 is a perspective view diagram illustrating an example of the rear suspension assembly, in accordance with examples of the subject disclosure; and

FIG. 14 is a perspective view diagram illustrating another example of the rear suspension assembly, in accordance with examples of the subject disclosure.

### DETAILED DESCRIPTION

Reference throughout this specification to “one example,” “an example,” or similar language means that a particular feature, structure, or characteristic described in connection with the example is included in at least one example. Thus, appearances of the phrases “in one example,” “in an example,” and similar language throughout this specification may, but do not necessarily, all refer to the same example, but mean “one or more but not all examples” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more examples. In the following description, numerous specific details are provided to give a thorough understanding of examples of the disclosure. One skilled in the relevant art will recognize, however, that the example may be practiced without one or more of the specific details, or with other methods, components, materials, and so forth. In other instances, well-known structures, materials, or operations are not shown or described in detail to avoid obscuring aspects of the disclosure.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

The present disclosure relates to snow vehicles including snow bikes and/or snow mobiles and in particular to a front ski assembly for the same. The front ski assembly serves as a connection mechanism between the steering assembly of the motorcycle and the ski. A selectively configurable front ski assembly is provided to fit a variety of different motorcycles. This patent discloses significant functional improvements over other snow bikes in performance, ease of installation, maintenance, mechanical integrity, reliability, and/or safety, as further described below.

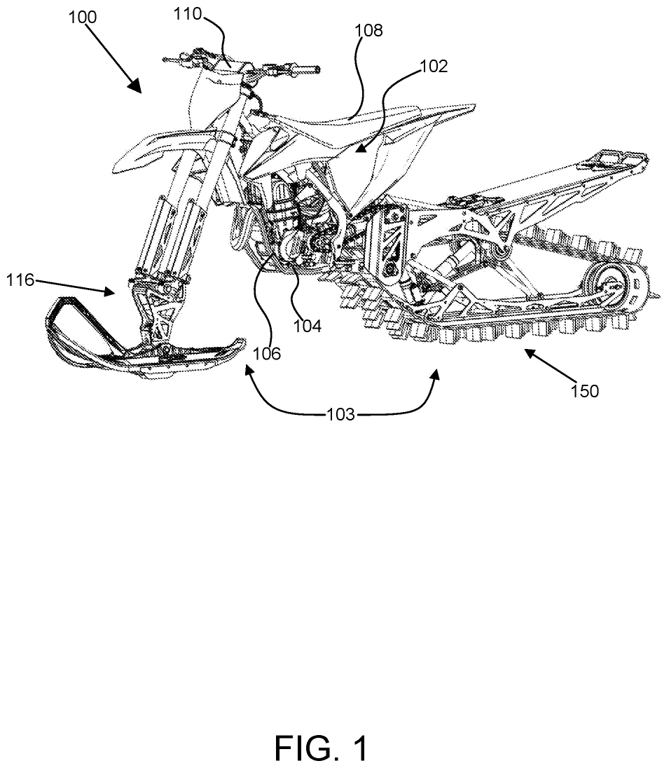

FIG. 1 is a perspective view diagram of a snow bike 100, in accordance with one or more examples of the present disclosure. In the example depicted, the snow bike 100 is formed of a motorcycle portion 102 combined with a conversion kit 103. The motorcycle portion 102, as known to those skilled in the art, generally includes a propulsion unit 104 (which is shown here as a four-stroke engine, but in the alternative may be a two-stroke engine, or electric), a frame 106, a seat 108 for an operator, and a steering assembly 110. The conversion kit 103 includes a front ski assembly 116 and a rear suspension assembly 150. The rear suspension assembly 150 will be described in greater detail below.

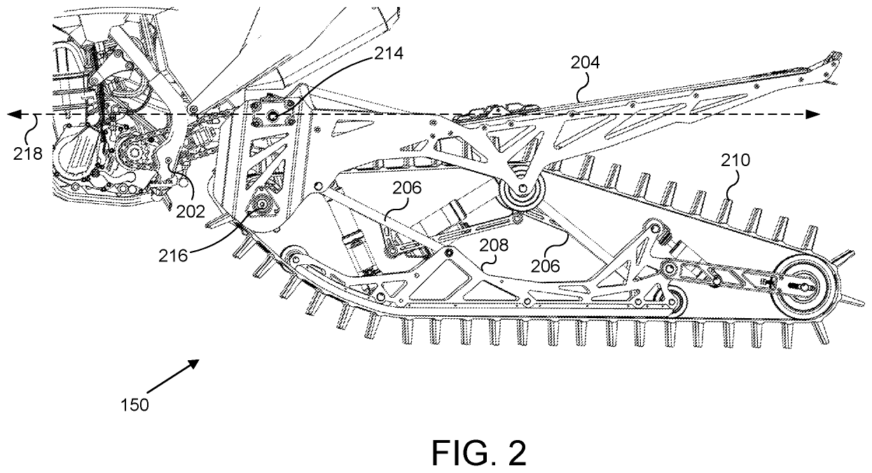

FIG. 2 is a side view diagram illustrating a partial view of the snow bike 100, in accordance with examples of the present disclosure. In the depicted example, the rear suspension assembly 150 is shown coupled to the motorcycle frame 106. The rear suspension assembly 150 is universal to all modern motocross, supercross, enduro, and off-road motorcycles, which are sometimes collectively known as “dirt bikes.” In other words, the rear suspension assembly 150 is adaptable to any dirt bike that includes a frame 106 and a swingarm pivot bolt 202 or axle. In almost all modern dirt bikes, the swingarm pivot bolt 202 secures the swingarm (not shown) to the frame 106 and the propulsion unit 104. Stated differently, the swingarm pivot bolt 202 passes through the frame 106 and the propulsion unit (hereinafter “motor”) 104. Gaps exist between the motor 104 and the frame 106, and the swingarm of each different variation of dirt bike is adapted to fit into those gaps. Because each manufacturer creates and sells many different models of dirt bikes, conventional snow bike conversion kits have had to create so-called “fit-kits” for each model. Some conventional snow bike conversion kits are available with 100 different fit-kits.

Beneficially, the examples of the present disclosure describe a rear suspension assembly 150 that is universal and does not require a fit kit. The present disclosure describes various unique combinations of features that enable universal fit while taking into account performance, ease of installation, maintenance, mechanical integrity, reliability, and/or safety.

The rear suspension assembly 150 is formed of a tunnel 204 that couples to the frame 106, suspension members 206 that are pivotally coupled to the tunnel 204 and to slide rails 208, and an endless track 210 that surrounds the suspension members 206 and the slide rails 208. In certain examples, a chain 212 motively couples the motor 104 to the endless track 210 via a jack shaft 214 and a drive shaft 216, which will be described in greater detail below.

Also shown in FIG. 2 is a line that depicts a longitudinal axis 218 of the snow bike 100. The longitudinal axis 218 may extend from the front (i.e., the front ski assembly 116) to the rear (i.e., the end of the rear suspension assembly 150), and may pass through a center of gravity of the snow bike 100, and bisect the snow bike 100 down the middle lengthwise.

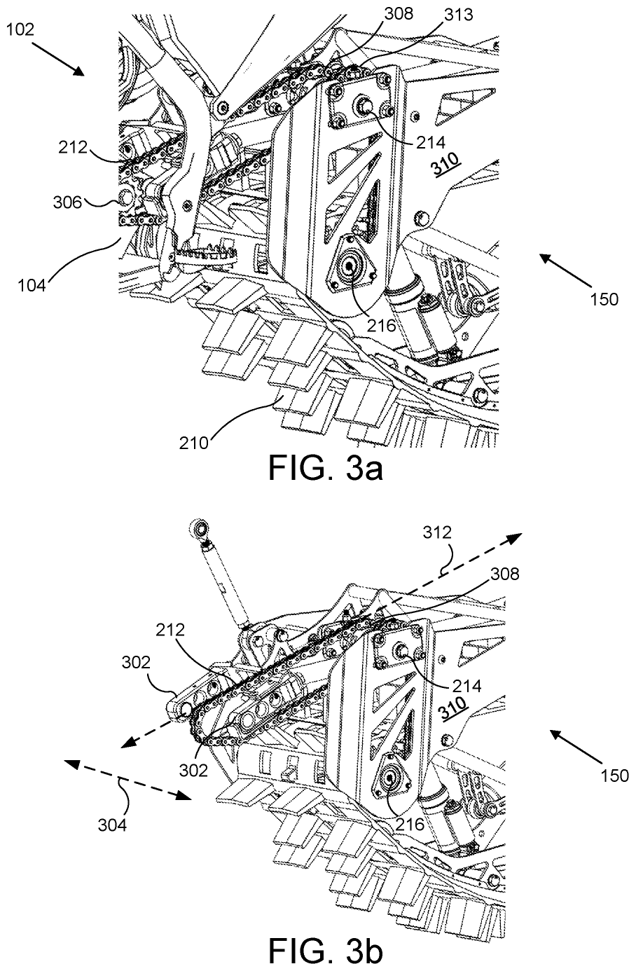

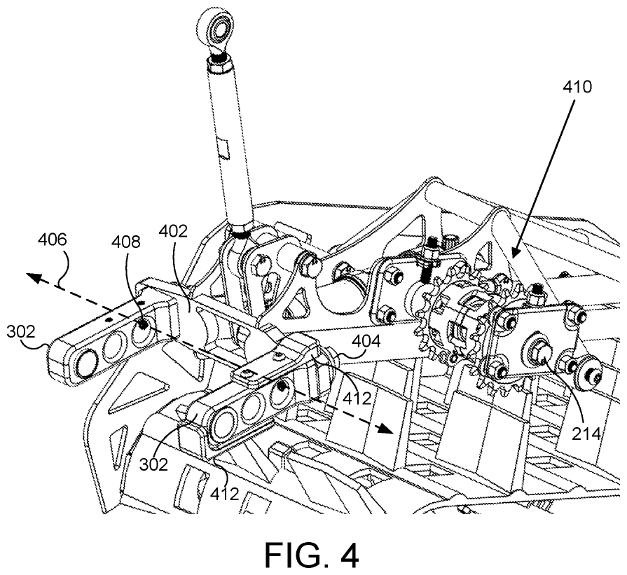

FIGS. 3a and 3b are perspective view diagrams illustrating examples of the rear suspension assembly 150 (with and without the motorcycle portion 102, respectively), in accordance with examples of the present disclosure. The depicted examples illustrate partial views of the rear suspension assembly 150 and its coupling mechanism to the frame 106. In certain examples, the rear suspension assembly 150 includes a pair of mount legs 302 which are slidably coupled with a mount plate (see FIG. 4) of the tunnel 204. In certain examples, the mount legs 302 are adjustable in a side-to-side direction as indicated by arrow 304. The side-to-side direction, in certain examples, is transverse to the longitudinal axis 218. This, beneficially, allows the rear suspension assembly 150, to accommodate almost every make and model of modern dirt bike because the mount legs 302 are positionable, with reference to the rear suspension assembly 150, to accommodate different frame 106 and motor 104 widths. Stated differently, the mount legs are positionable to be insertable into the gaps between any motor 104 and any frame 106. In other words, the mount legs 302 are positionable laterally to create a distance between the mount legs that approximates the width of a removed dirt bike swingarm (not shown).

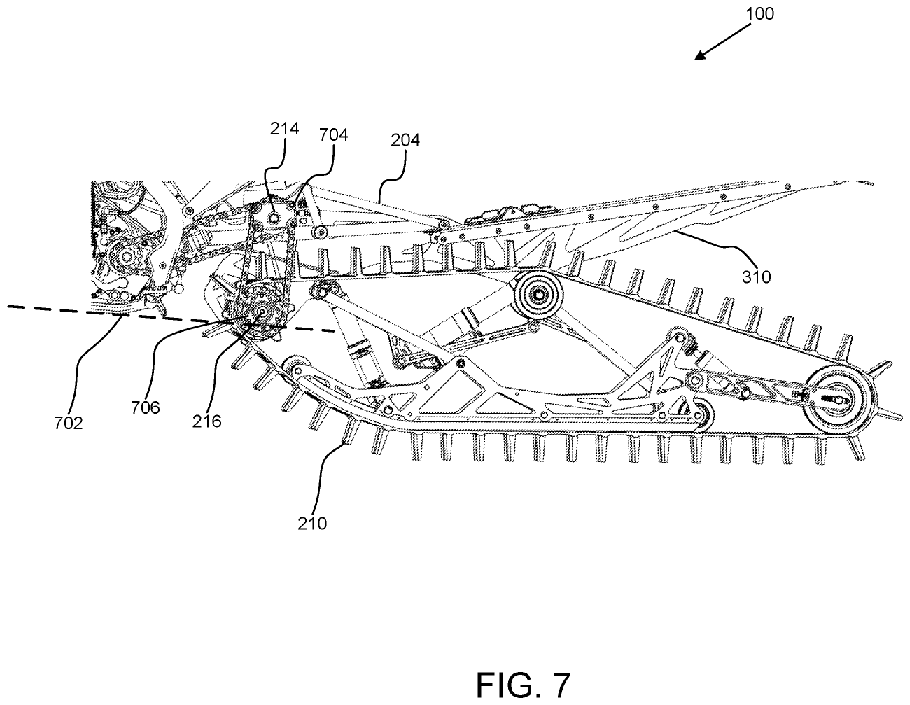

The motor 104 provides a motive force to the endless track 210 via the chain 212. The chain 212 engages a driving sprocket 306, that is coupled to a transmission output shaft of the motor 104, and a driven sprocket 308 rotatably coupled with the jack shaft 214. The driven sprocket 308 is formed as part of a rotatable hub that includes a second sprocket 313. The second sprocket 313 rotates with the driven sprocket 308 to transfer a motive force to the drive shaft 216. Beneficially, the drive shaft chain (see FIG. 7) is disposed inside of a side portion 310 of the tunnel 204. This protects the drive shaft chain from being damaged or causing damage to the operator.

In certain examples, the positionable mount legs 302 allow the driven sprocket 308 to be longitudinally aligned with the driving sprocket 306. As used herein, longitudinally aligned refers to the driving sprocket 306 and the driven sprocket 308 having substantially equal distances, perpendicularly, from a vertical plane that extends through the longitudinal axis 218 (i.e., splits the dirt bike in half lengthwise or longitudinally). As used herein with respect to the present disclosure, “substantially” refers to a value that is within ±10% of the cited quantity or value. In other words, a line 312 defined by a segment of the chain 212 that spans between the sprockets would be substantially parallel with a vertical plane that extends through the longitudinal axis 218.

FIG. 4 is a perspective view diagram illustrating a partial view of the rear suspension assembly 150, in accordance with examples of the present disclosure. In particular, FIG. 4 illustrates an example with many components hidden (e.g., the side portion 310) to give a better understanding of the spatial arrangement of the mount legs 302 with respect to the tunnel 204. The mount legs 302, in certain examples, extend forward from a mounting plate 402. The mounting plate 402 may be formed with substantially horizontally oriented slots to allow for fasteners 404, that couple the mount legs 302 to the mounting plate 402, to be positioned laterally with respect to the tunnel 204. As used herein, the term “positioned laterally” refers to the mount legs 302 being positionable along an axis 406 that is transverse to the longitudinal axis 218.

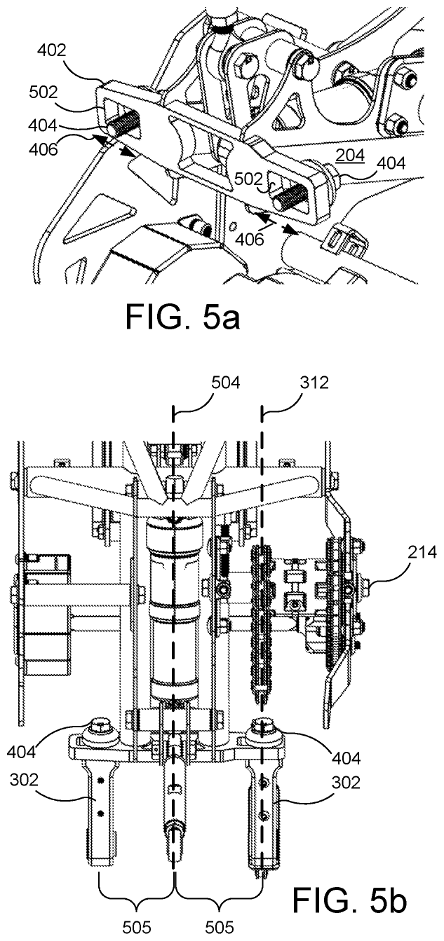

In certain examples, the fastener 404 is a threaded bolt that engages a threaded opening 408 and passes through the horizontally, elongated slots (see FIG. 5a) to secure the position of the mount legs 302 with respect to the mount plate 402.

The mount legs 302 may be formed with one or more openings, at least one of which allows for a swingarm bolt/axle to pass through and secure the rear suspension assembly 150 to the motorcycle portion 102 (see FIG. 1). Also depicted is a drive hub 410 that is rotatably coupled with the jack shaft 214. The other depicted openings may be ornamental, or functional (i.e., useful for adjusting the position of the mount legs 302 forward or backwards with reference to the frame 106).

In certain examples, chain guards 412 are proved and coupled to the mount leg 302 that is positioned on the chain side of the motorcycle portion 102. Beneficially, the chain guards 412 prevent chain slap from damaging the mount leg 302. The chain guards 412 may be sacrificial and replaceable, and formed of a polymeric material.

FIG. 5a is a perspective view diagram illustrating a view of the mounting plate 402, in accordance with examples of the subject disclosure. The mounting plate 402, as described above, is formed with horizontally elongated slots 502 to allow for the fasteners 404 to be positionable laterally with respect to the mounting plate 402. The mounting plate 402, in certain examples, is formed as part of the structure of the tunnel 204. In alternative examples, the mounting plate 402 is formed separately and attached to the tunnel 204.

As depicted, the fasteners are independently positionable to allow for the mount legs 302 to likewise be positioned independent of each other. This, beneficially, allows for the coupling of the rear suspension assembly 150 to a motorcycle portion 102 that may have an asymmetric swingarm. In other words, one of the mount legs 302 may be positioned closer to a centerline (i.e., a vertical plane that passes through the longitudinal axis) than the other mount leg 302. In other examples, the mount legs 302 are symmetrically positioned on the mounting plate 402.

FIG. 5b is a top view diagram illustrating another example of the mounting plate 402, in accordance with examples of the subject disclosure. As depicted, the mounting plate 402 may have a downward facing orientation, or in other words, not vertically oriented. This angle allows for the jack shaft 214 to be positioned above the driving sprocket 306 (see FIG. 2, for example). The mount legs 302 are positionable within the elongated slots 502 independently of each other, and may be positioned at different distances 505 from a centerline 504. As described above, the mount legs 302 are positionable along an axis that is transverse to the centerline 504 (i.e., the longitudinal axis). When adjusted properly, the chain line 312 is substantially parallel with the centerline 504.

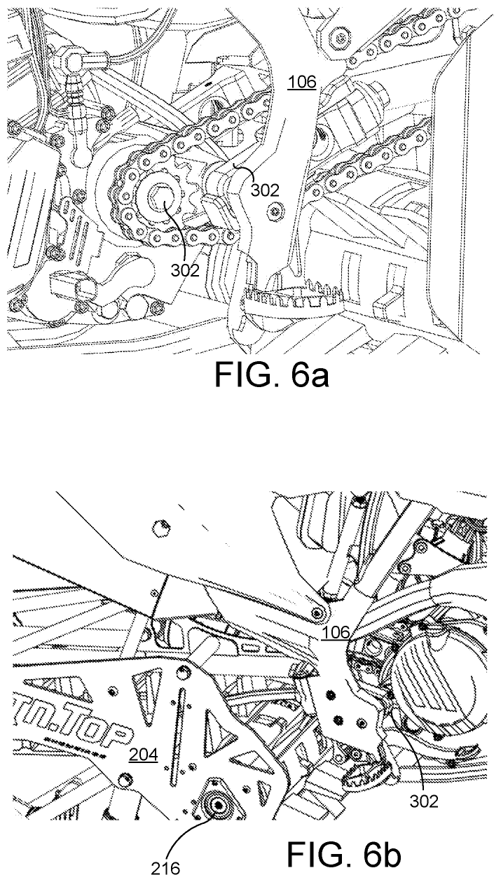

FIGS. 6a and 6b are perspective view diagrams illustrating left and right sides, respectively, of the mount legs 302, in accordance with examples of the subject disclosure. As described above, the mount legs 302 insert into openings between the frame 106 and the motor 104 that resulted from the removal of the swingarm (not shown). Beneficially, the mount legs 302 are positionable to fit all makes and models of modern dirt bikes. Additionally, the mount legs 302 angle upward from the swingarm pivot bolt 202 (i.e., swingarm pivot axle) so that the jack shaft 214 is positioned at a height, if measured from a flat surface, greater than the transmission output shaft. As will be described in greater detail below, having the jack shaft in such an orientation allows for the drive shaft to be above a bottom of the frame 106. This beneficially improves the ride of the snow bike 100 because the front of the endless track 210 does not as easily impact obstacles in the path of the snow bike 100.

FIG. 7 is a side view diagram illustrating a partial view of the snow bike 100, in accordance with examples of the subject disclosure. In the depicted example, one of the side portions 310 of the tunnel 204 is removed for clarity. A plane 702, defined by the bottom of the frame 106 is extended to illustrate the position of the drive shaft 216 with respect to the frame 106. Conventional snow bike conversion kits position the drive shaft below a plane defined by the frame. Beneficially, by shifting the jack shaft 214 and drive shaft 216 upwards, the drive shaft 216 is positioned above the plane 702. Impacts to the front of the endless track 210 adjacent to the drive shaft 216 are significantly reduced because of the position of the front of the endless track 210 relative to the frame 106 (i.e., the frame 106 shields the front of the endless track 210 that is adjacent the drive shaft 216). This greatly improves ride comfort.

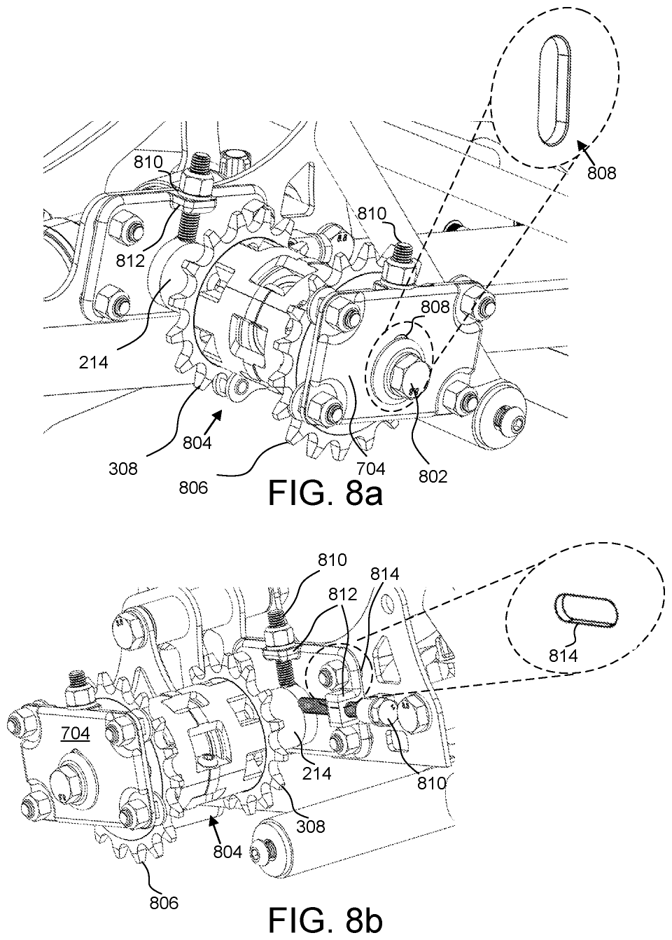

Although the side portion 310 of the tunnel is hidden in this view, the brackets that support the jack shaft 214 and the drive shaft 216 are shown, and will now be discussed. The jack shaft 214 is supported at each end by an adjustable jack housing 704. As will be described in greater detail below (see FIGS. 8a and 8b), a first jack housing 704 is secured to the side portion 310 and a second jack housing 704 is attached to the tunnel 204. The jack shaft 214 is secured at each end by either the first or the second jack housing 704. The jack housing 704 is provided with adjustment mechanisms that allow for the positioning of the jack shaft 214 along horizontal and vertical planes, relative to the tunnel 204. Beneficially, this allows for the proper chain tension to be applied to the chain 212 without having an additional wheel or other type of chain tensioning mechanism, which may function to rob horsepower to the endless track 210.

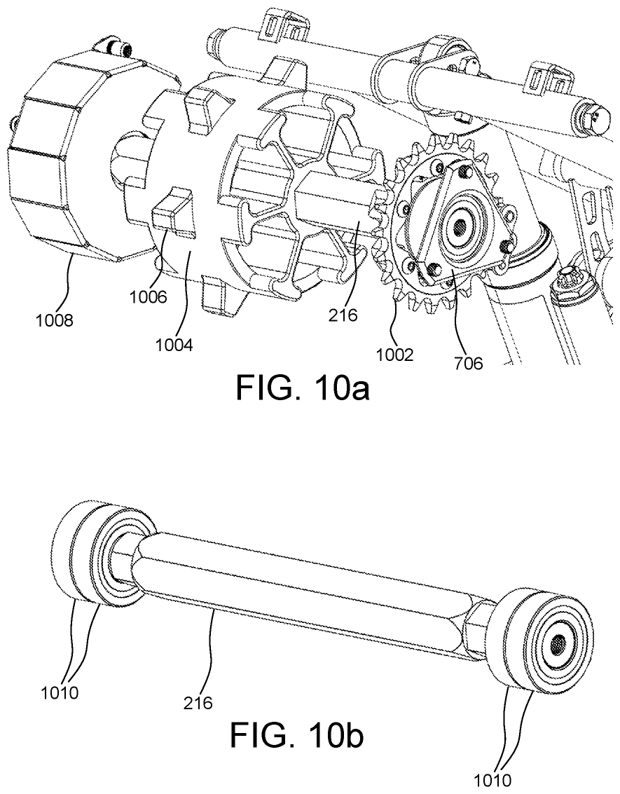

The drive shaft 216 is coupled at each end to one of the side portions 310 via a bearing housing 706. Each bearing housing 706, in certain examples, is configured to house a pair of bearings (see FIG. 10b). Beneficially, by using a pair of bearings at each end of the drive shaft 216, a lighter weight (i.e., aluminum) drive shaft 216 may be utilized which also reduces the rotating mass of the rear suspension assembly 150 and improves efficiency.

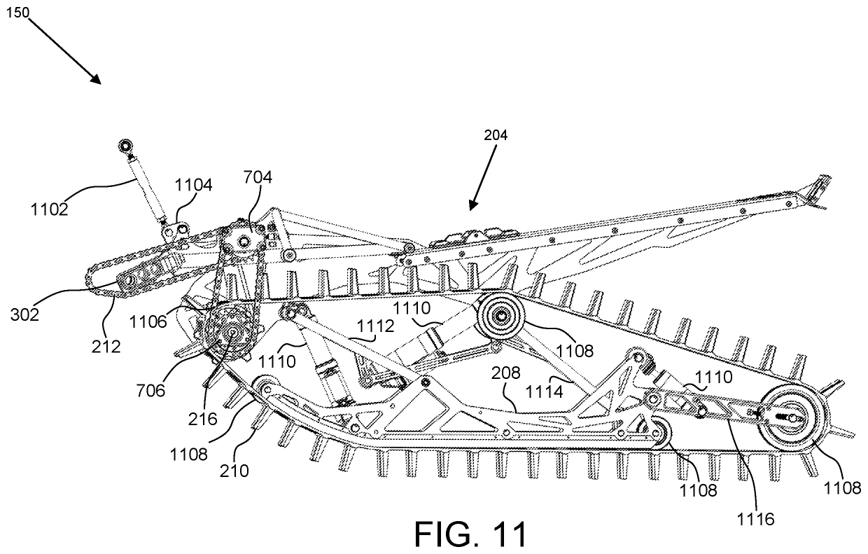

FIGS. 8a and 8b are perspective view diagrams illustrating examples of the jack shaft 214, in accordance with examples of the present disclosure. FIG. 8a illustrates the jack shaft 214 from a point of view in front of the jack shaft 214, while FIG. 8b illustrates the point of view from the rear. In the depicted example, the jack shaft 214 is fixed at each end by a fastener 802 to one of the jack housings 704. The jack shaft 214, in certain examples does not rotate relative to the jack housings 704, instead a sprocket hub 804 rotates about the jack shaft 214. The sprocket hub 804 includes the driven sprocket 308, which is motively coupled via the chain 212 with the motor 104, and drive shaft sprocket 806 that transfers the motive force from the motor 104, via the driven sprocket 308, to the drive shaft 216 (see FIG. 11).

Each jack housing 704 includes a vertically oriented slot 808 (as shown in the callout) that allows the jack shaft 214 and the fastener 802 to be moved and subsequently fixed in different vertical positions relative to the jack housing 704. An adjustment mechanism 810, for example, a threaded rod and a bolt, maintains the desired vertical position of the jack shaft 214. In certain examples, the jack housing 704 includes one or more shoulders 812 that extend towards the sprocket hub 804. The shoulders 812 may include threaded openings that receive the adjustment mechanism 810 and allow the adjustment mechanism 810 to define a vertical position of the jack shaft 214 with respect to the jack housing 704.

In a similar fashion, slots 814, that are horizontally oriented, allow for the horizontal positioning of the jack shaft 214 in a forward and backward position. As used herein with respect to the jack shaft 214, “forward” refers to a position that is towards the front of the snow bike 100, and “backward” refers to a position that is towards the rear of the snow bike 100. Together, adjusting the vertical and horizontal position of the jack shaft 214, beneficially, allows the chain 212 to have the proper tension without additional pulleys, rollers, tensioners, etc., that may affect the efficiency of the drive system (i.e., the delivery of the motive force from the motor to the endless track). Although FIGS. 8a and 8b omit certain components for the sake of clarity, it is to be understood that vertical slots 808 and horizontal slots 814 are formed in the rear suspension assembly 150 adjacent the jack housing 704 of each end of the jack shaft 214.

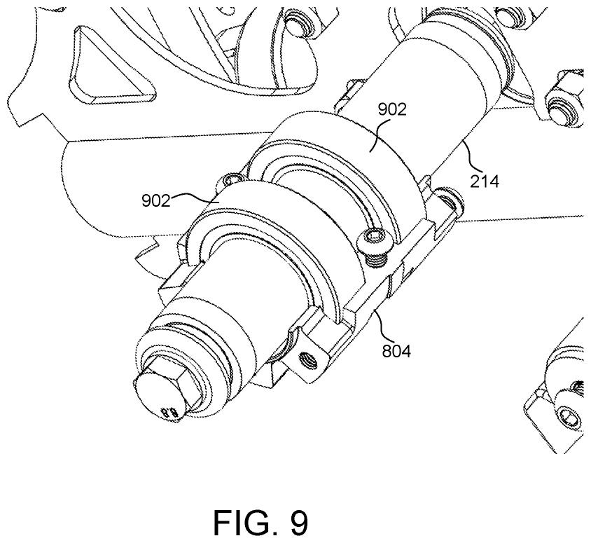

FIG. 9 is a perspective view diagram illustrating a partial view of the jack shaft 214 and the sprocket hub 804, in accordance with examples of the subject disclosure. In the depicted example, various components are hidden for the sake of clarity. In this illustration, a portion of the sprocket hub 804 is hidden to better depict the jack shaft 214 and the bearings 902 that support the sprocket hub 804. As discussed above, the jack shaft 214 may be fixed rotationally with respect to the tunnel 204. The sprocket hub 804 rotates about the jack shaft 214 on the bearings 902.

FIG. 10a is a perspective view diagram illustrating one example of the drive shaft 216, in accordance with examples of the subject disclosure. The drive shaft 216 is disposed between side portions 310 of the tunnel 204, which are not shown in this illustration for the sake of clarity. The drive shaft 216, in certain examples, is formed of a rigid metal or metallic alloy material. In certain examples, the drive shaft 216 is coupled at each end to a bearing housing 706. Each bearing housing 706 is coupled to a side portion 310 of the tunnel. Various components may be disposed on the drive shaft 216, including a sprocket 1002 and a driver 1004.

In certain examples, the sprocket 1002 is motively coupled, via a chain, with one of the sprockets of the sprocket hub 804 (see FIG. 11). As such, the motive force of the motor 104 is transferred from the sprocket hub 804 to the endless track 210 via the driver 1004 of the drive shaft 216. The driver 1004, in certain examples, includes teeth 1006 extending from an outer surface of the driver to engage openings of the endless track 210 in a manner that is known to those skilled in the art of snow biking. A disk braking system 1008 is also coupled with the drive shaft 216, and may be enclosed as depicted.

FIG. 10b is a perspective view diagram illustrating another example of the drive shaft 216, in accordance with examples of the subject disclosure. The drive shaft 216 may be formed with a polygonal cross-section so that the motive force is efficiently transferred to the driver 1004 via a correspondingly shaped opening. Other force transferring mechanisms are contemplated, including a key and keyseat, etc. In certain examples, the cross-section of the drive shaft 216 is hexagonal, as depicted. Other symmetric cross-sectional profiles are contemplated, including but not limited to circles, etc.

Disposed at each end of the drive shaft 216, in certain examples, is a pair of bearings 1010. The bearings 1010 ride within the bearing housing 706 and support the drive shaft 216. As discussed above, by providing multiple bearings 1010, the torsional forces experienced by the drive shaft 216 are better distributed and a lighter weight drive shaft 216 may be used. For example, the drive shaft 216 may be formed of a high-strength aluminum alloy. A lighter weight drive shaft 216 beneficially reduces the rotating mass of the system that rotates the endless track 210.

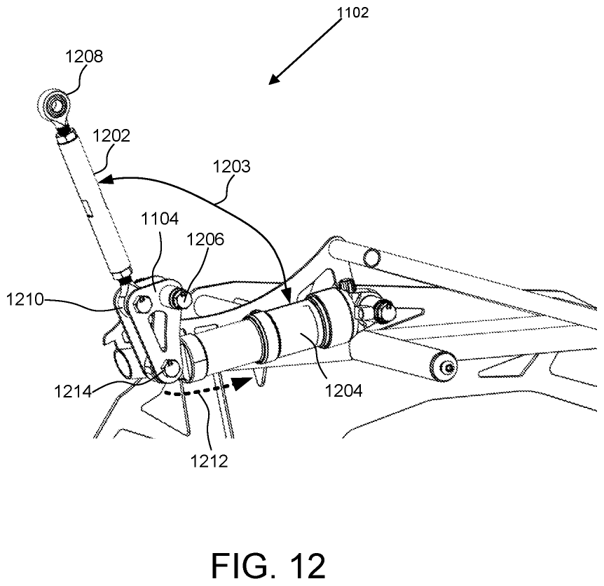

FIG. 11 is a side view diagram illustrating another example of the rear suspension assembly 150, in accordance with examples of the subject disclosure. The rear suspension assembly 150 is depicted here with the side portion 310 (see FIG. 3a) removed for the sake of clarity. The rear suspension assembly 150, as mentioned above, is coupled to the motorcycle portion 102 of the snow bike 100 via the mount legs 302. In certain examples, the rear suspension assembly 150 also couples to the motorcycle portion 102 at an upper shock mount location of the motorcycle portion 102 via a live strut 1102. As will be described in greater detail below with reference to FIG. 12, the live strut 1102 connects at a first end to the motorcycle portion 102 and at a second end to a linkage bracket 1104. The linkage bracket 1104 pivots about a pivot point and is biased by a shock absorber (see FIG. 12).

The chain 212 transfers the motive force of the motor 104 to the drive shaft chain 1106 which in turn rotates the drive shaft 216, which turns the endless track 210. Disposed within the endless track 210 is the suspension system which includes the slide rails 208, bogey wheels 1108, shock absorbers 1110, and various control arms 1112, 1114.

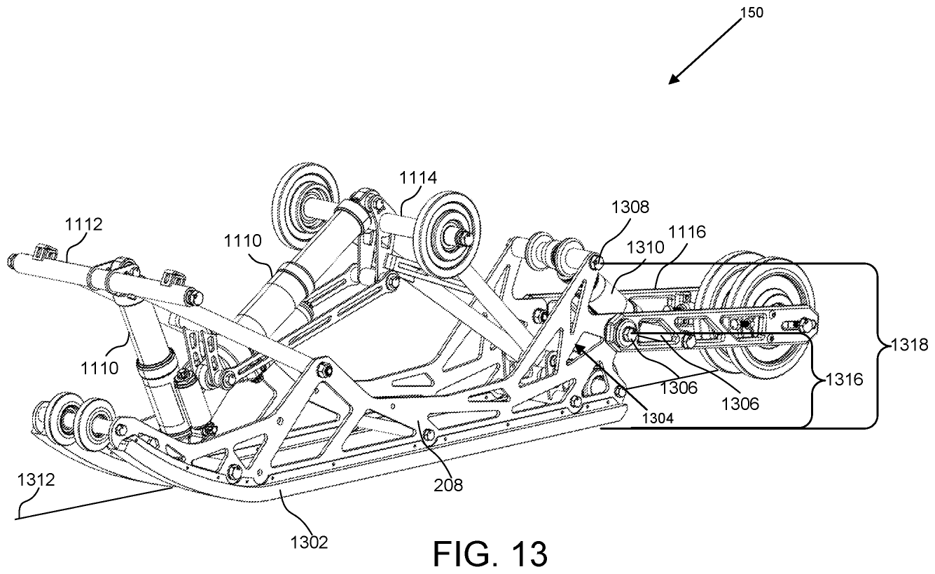

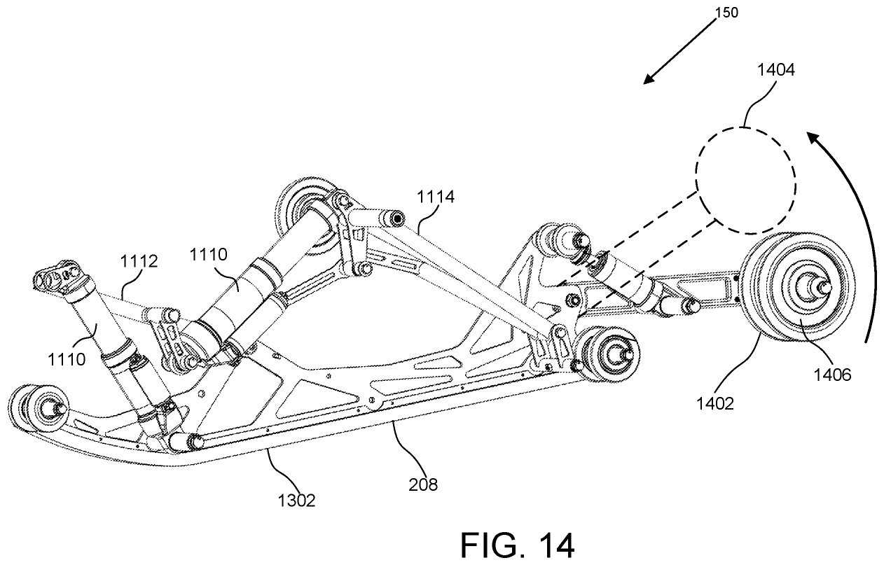

In certain examples, the rear suspension assembly 150 includes a “live slide rail” 1116 that extends rearward from and is pivotally coupled with the slide rail 208. The term “live slide rail” refers to a slide rail that is movable with reference to the slide rail 208. In certain examples, the live slide rail 1116 is biased downward by one of the shock absorbers 1110. The benefits and features of this will be described in greater detail below with reference to FIGS. 13 and 14.

FIG. 12 is a perspective view diagram illustrating one example of the live strut 1102, in accordance with examples of the subject disclosure. The live strut 1102, in certain examples, may refer to the entire coupling mechanism that includes a strut 1202, the linkage bracket 1104 and a shock absorber 1204. The strut 1202 couples at a first end 1208 to the motorcycle portion 102. For example, the strut 1202 may be configured to couple to the upper shock mount of the motorcycle portion 102. Stated differently, when converting a dirt bike into a snow bike 100, the operator typically removes the swing arm, rear wheel, and the rear shock absorber.

The strut 1202 couples to the motorcycle portion 102 in place of the rear shock absorber at the first end 1208. Relative movement between the motorcycle portion 102 and the rear suspension assembly 150 may be partially dampened by the live strut 1102. The dampening occurs because as the strut 1202 causes the linkage bracket to rotate about the pivot point 1206, the linkage bracket pushes on the shock absorber 1204, in a direction indicated by the arrow 1212, at the shock absorber pivot point 1214. The linkage bracket 1104, in certain examples, is formed with 3 coupling positions; one to couple with the second end 1210 of the strut 1202, one to couple to the tunnel 204 at the pivot point 1206, and one to couple with the shock absorber 1204. Fasteners, such as a nut and bolt, may be used to couple the various components to the linkage bracket 1104.

In certain examples, the shock absorber 1204 is an air shock absorber such as a Fox Float produced by FOX Factory, Inc. In other examples, the shock absorber 1204 is a liquid-based shock absorber, or an external reservoir shock absorber, spring-based shock absorber, etc. The shock absorber 1204 may be adjustable to control the level of dampening. Additionally, the operating pressure of the shock absorber 1204 may be adjusted to accommodate operator preference.

In certain examples, the strut 1202 is oriented in a mostly vertical orientation (i.e., within 20 degrees of vertical) and the shock absorber 1204 is oriented in a mostly horizontal orientation (i.e., within 20 degrees of horizontal). At rest, an angle 1203 of separation is in the range of between about 70 and 110 degrees. In another example, the angle 1203 of separation is approximately 90 degrees, as depicted. As used herein with reference to FIG. 12, the term “approximately” refers to a value that is ±20% of the cited value. Beneficially, by using the linkage bracket 1104 to couple the strut 1202 to the shock absorber 1204, the shock absorber 1204 can be run at lower air pressures for greater adjustability. Conversely, common snow bike conversion kits that use air shocks require that the air shock be maxed out, thereby limiting the adjustability of the shock for operator preference.

Referring jointly now to FIGS. 13 and 14, shown are perspective view diagrams illustrating examples of the rear suspension assembly 150, in accordance with examples of the subject disclosure. For clarity, the rear suspension assembly 150 is show in FIGS. 13 and 14 with multiple components hidden. Additionally, in FIG. 14, one of the slide rails 208 is hidden. As discussed above, the rear suspension assembly 150 includes a pair of slide rails 208. The slide rails 208 support the endless track 210 and may be fitted with a low friction, replaceable surface commonly known as hyfax 1302. The hyfax 1302 is a wear surface upon which the endless track 210 rotates. With the endless track 210 removed, as depicted here, the hyfax 1302 forms a ground engaging surface. The slide rails 208 are spaced apart a distance by the front control arm 1112 and the rear control arm 1114. The slide rails 208 are provided, in certain examples, with multiple mount points for the shock absorbers 1110, control arms 1112, 1114, and bogey wheels 1108.

In certain examples, each slide rail 208 includes a tower 1304 for mounting the live slide rail 1116. The tower 1304 refers to a portion of the slide rail 208 that extends upward from the mostly horizontally oriented slide rail 208. Usage of the term “horizontal” is used for reference only when describing the orientation of the components as resting on a flat surface that is horizontal. In other words, although the snow bike 100 is useful in mountainous regions, the description of the components contained herein is described as if sitting on a level, horizontal, garage floor.

The tower 1304 may include a first mount point 1306 for pivotally coupling with the live slide rail 1116 and a second mount point 1308 for pivotally coupling the slide rails 208 with a shock absorber 1310 that is adapted for biasing the live slide rail 1116 downward. As used herein, the term “downward” refers to a direction towards the ground 1312. The shock absorber 1310 is coupled at a first end to the tower 1304 (or a bar that spans between towers 1304) and at a second end to a bar 1314 that spans between the live slide rails 1116. In certain examples, the first mount point 1306 is positioned at a first distance 1316 from the ground 1312 that is less than a second distance 1318 of the second mount point 1308.

In certain examples, the live rail 1116 is moveable between a first position 1402 and a second position 1404. The first position 1402, as depicted, is the default position where, when sitting on a level floor, the live rail bogey wheel 1406 is also resting on level floor. The shock absorber 1310 biases the live rail 1116 towards the first position 1402. The second position 1404 is elevated above the level floor. In use, the live slide rail 1116 beneficially allows the rear suspension assembly 150 to articulate in certain riding situations when the front ski assembly is elevated above the ground (e.g., executing a “wheelie”). Conventional rear suspension assemblies have non-articulating slide rails, and when wheelieing only a portion of the slide rail is able to maintain traction because a large portion of the slide rail is also elevated from the ground. Beneficially, the rear suspension assembly 150 of the subject disclosure improves rideability and performance because of the articulating nature of the slide rails 208 and the live slide rail 1116. The shock absorber 1310 is adjustable to allow the operator to increase or decrease the biasing force that returns the live slide rail 1116 to the first position 1402.

The present disclosure may be embodied in other specific forms without departing from its spirit or essential characteristics. The described examples are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising:
a rear suspension assembly for converting a rear portion of a motorcycle for use as a snow vehicle, the rear suspension assembly comprising:
a tunnel; and
a mount plate coupled to the tunnel; and
a pair of mount legs, where each of the pair of mount legs is positionably coupled to the mount plate at a first end and rotationally coupled at a second end to a frame of the motorcycle, and where each of the pair of mount legs is positionable independent of the other mount leg.

2. The apparatus of claim 1, where the mount plate includes an elongated slot for each of the pair of mount legs.

3. The apparatus of claim 2, where each of the elongated slots is adapted for the lateral positioning of the pair of mount legs with respect to a centerline.

4. The apparatus of claim 3, further comprising a fastener for each of the pair of mount legs, where the fastener is configured to pass through the slot and secure its respective mount leg to the mount plate.

5. The apparatus of claim 4, where a lateral distance from the centerline of a first one of the pair of mount legs is substantially equivalent to a lateral distance from the centerline of a second one of the pair of mount legs.

6. The apparatus of claim 4, where a lateral distance from the centerline of a first one of the pair of mount legs is greater than a lateral distance from the centerline of a second one of the pair of mount legs.

7. The apparatus of claim 1, further comprising a linkage bracket having a first mount point pivotally coupled with a first end of a strut, a second mount point pivotally coupled with a first end of a shock absorber, and a third mount point pivotally coupled with the tunnel.

8. The apparatus of claim 7, further comprising a second end of a strut that is pivotally coupled with an upper shock mount of the frame of the motorcycle.

9. The apparatus of claim 8, further comprising a second end of the shock absorber that is pivotally coupled with the tunnel.

10. The apparatus of claim 7, further comprising an angle of separation between the strut and the shock absorber in a range of between about 70 and about 110 degrees.

11. An apparatus comprising:
a rear suspension assembly for converting a rear portion of a motorcycle for use as a snow vehicle, the rear suspension assembly comprising:
a tunnel; and
a linkage bracket having a first mount point pivotally coupled with a first end of a strut, a second mount point pivotally coupled with a first end of a shock absorber, and a third mount point pivotally coupled with the tunnel.

12. The apparatus of claim 11, further comprising a second end of a strut that is pivotally coupled with an upper shock mount of the frame of the motorcycle.

13. The apparatus of claim 12, further comprising a second end of the shock absorber that is pivotally coupled with the tunnel.

14. The apparatus of claim 11, further comprising an angle of separation between the strut and the shock absorber in a range of between about 70 and about 110 degrees.

15. The apparatus of claim 11, further comprising a mount plate coupled to the tunnel.

16. The apparatus of claim 15, further comprising a pair of mount legs, where each of the pair of mount legs is positionably coupled to the mount plate at a first end and rotationally coupled at a second end to a frame of the motorcycle, and where each of the pair of mount legs is positionable independent of the other mount leg.

17. The apparatus of claim 16, where the mount plate includes an elongated slot for each of the pair of mount legs.

18. The apparatus of claim 17, where each of the elongated slots is adapted for the lateral positioning of the pair of mount legs with respect to a centerline.

19. The apparatus of claim 18, further comprising a fastener for each of the pair of mount legs, where the fastener is configured to pass through the slot and secure its respective mount leg to the mount plate.

20. A snow bike comprising:
a motorcycle frame;
a front suspension assembly coupled at a front of the motorcycle frame, the front suspension assembly having a ski; and
a rear suspension assembly coupled at a rear of the motorcycle frame, the rear suspension assembly comprising:
a tunnel; and
a mount plate coupled to the tunnel; and
a pair of mount legs, where each of the pair of mount legs is positionably coupled to the mount plate at a first end and rotationally coupled at a second end to a frame of the motorcycle, and where each of the pair of mount legs is positionable independent of the other mount leg.
